(19) United States
(12) Patent Application Publication
(10) Pub. No.: US 2022/0326038 A1
(43) Pub. Date: Oct. 13, 2022

(54) Method for Combined Control of Navigation Terminals and Vehicle System Providing the Same

(71) Applicants: Hyundai Motor Company, Seoul (KR); Kia Corporation, Seoul (KR)

(72) Inventors: Sojeong Kim, Seoul (KR); Donghyuk Oh, Seoul (KR); Jeongtaek Oh, Seoul (KR)

(21) Appl. No.: 17/643,444

(22) Filed: Dec. 9, 2021

(30) Foreign Application Priority Data
Apr. 13, 2021 (KR) 10-2021-0048049

(51) Int. Cl. G01C 21/36; B60K 35/00

(52) U.S. Cl. CPC G01C 21/3688; B60K 35/00; G01C 21/362; B60K 2370/166; B60K 2370/736; B60K 2370/739; B60K 2370/52; B60K 2370/184

(57) ABSTRACT

In an embodiment a vehicle system includes a driver terminal installed at a driver seat of a vehicle, a fellow passenger terminal installed at a non-driver seat of the vehicle and a processor configured to control the driver terminal to execute a navigation program for providing travel route information for a first destination by the driver terminal when destination information of the first destination is received through the driver terminal or the fellow passenger terminal, wherein the travel route information includes a map for displaying a shortest travel route to the first destination from a real-time position of the vehicle.

### CROSS-REFERENCE TO RELATED APPLICATIONS

This application claims the benefit of Korean Patent Application No. 10-2021-0048049, filed in the Korean Intellectual Property Office on Apr. 13, 2021, which application is hereby incorporated herein by reference.

### TECHNICAL FIELD

The present invention relates to a method for controlling a plurality of navigation terminals installed at a driver seat and a non-driver seat of a vehicle in a combined way, and related a vehicle system.

### BACKGROUND

A navigation terminal in a vehicle is installed at a driver seat, so when there is no occupant sitting in a seat beside it, a driver has to directly input a destination into a navigation terminal.

When the driver needs to change the destination while driving the vehicle, he may not focus on driving while re-inputting (or searching) the destination, and as a result, possibilities of car crashes may increase. Particularly, in the case of commercial motor vehicles, the driver may not frequently know the position and information for the destination. Hence, the passenger (or the occupant) frequently changes the destination during a ride.

Therefore, a need for establishing environments for the driver to focus only on driving may be desired.

### SUMMARY

Embodiments provide a combined control method for operating a navigation terminal so that the driver can focus on driving when a destination is changed during driving. Further embodiments provide a related vehicle system.

An embodiment provides a vehicle system including a driver terminal installed near a driver's seat of a vehicle; a fellow passenger terminal installed near a non-driver's seat of the vehicle; and a processor for, when receiving destination information on a first destination through the driver terminal or the fellow passenger terminal, controlling the driver terminal to execute a navigation program for providing travel route information on the first destination in the driver terminal, wherein the travel route information includes a map for displaying a shortest travel route to the first destination from a real-time position of the vehicle.

The processor may control the fellow passenger terminal to allow the fellow passenger terminal to provide driving information including at least one piece of information of an expected time of arrival at the first destination, a remaining travel distance, and a travel route when the navigation program for providing travel route information on the first destination is executed.

When destination information on a second destination is input through the driver terminal or the fellow passenger terminal while the navigation program on the first destination is executed, the processor may stop provision of travel route information on the first destination, and may control the driver terminal so that the navigation program for providing travel route information on the second destination is executed by the driver terminal.

When the navigation program for providing travel route information on the second destination is executed, the processor may control the fellow passenger terminal to allow the fellow passenger terminal to provide driving information including at least one piece of information of an expected time of arrival at the second destination, a remaining travel distance, and a travel route.

Another embodiment provides a vehicle system including a driver terminal installed near a driver's seat of a vehicle; a fellow passenger terminal installed near a non-driver's seat of the vehicle; a communicator for receiving a call signal of an occupant including destination information on a first destination from a server; and a processor for, when the occupant gets in the vehicle after acceptance on the call signal, controlling the driver terminal to allow a navigation program for providing travel route information on the first destination to be executed by the driver terminal, wherein, when destination information on a second destination is input through the fellow passenger terminal while the navigation program on the first destination is executed, the processor stops provision of travel route information on the first destination, and controls the driver terminal so that navigation program for providing travel route information on the second destination is executed by the driver terminal, and the travel route information includes a map for displaying a shortest travel route to the first destination or the second destination from a real time position of the vehicle.

The processor may control the fellow passenger terminal so that driving information on the first destination is provided by the fellow passenger terminal when destination information on the first destination is input, the processor may control the fellow passenger terminal so that driving information in which the first destination is changed into the second destination is provided by the fellow passenger terminal when destination information on the second destination is re-input, and the driving information may include at least one piece of information of an expected time of arrival at the first destination or the second destination, a remaining travel distance, and a travel route.

Another embodiment provides a combined control method of a navigation terminal including inputting destination information through a fellow passenger terminal installed near a non-driver's seat of a vehicle; controlling a driver terminal to allow a navigation program for providing travel route information on a destination to be executed by the driver terminal installed near a driver's seat of the vehicle; and controlling the fellow passenger terminal to allow driving information including at least one piece of information of an expected time of arrival at the destination, a remaining travel distance, and a travel route to be provided by the fellow passenger terminal, wherein the travel route information includes a map for displaying a shortest travel route to the destination from a real time position of the vehicle.

Another embodiment of provides a combined control method of a navigation terminal, including controlling a driver terminal to allow a navigation program for providing travel route information on a destination to be executed by a driver terminal installed near a driver's seat of a vehicle; and controlling a fellow passenger terminal to allow driving information including at least one piece of information of an expected time of arrival at the destination, a remaining travel distance, and a travel route to be provided by the fellow passenger terminal installed near a non-driver's seat of the vehicle, wherein the travel route information includes a map for displaying a shortest travel route to the destination from a real time position of the vehicle.

The combined control method may further include, before the controlling of a driver terminal, inputting destination information through the driver terminal.

Another embodiment provides a combined control method of a navigation terminal, including receiving a call signal of an occupant including destination information on a first destination from a server; controlling a driver terminal to allow a navigation program for providing travel route information on the first destination to be executed by the driver terminal installed near a driver's seat of a vehicle when the call signal is accepted and the occupant gets in the vehicle; controlling a fellow passenger terminal to allow driving information on the first destination to be provided by the fellow passenger terminal installed near a non-driver's seat of the vehicle; stopping provision of travel route information on the first destination when destination information on a second destination is input through the fellow passenger terminal, and controlling the driver terminal to allow a navigation program for providing travel route information on the second destination to be executed by the driver terminal; and controlling the fellow passenger terminal to allow driving information in which the first destination is changed to the second destination to be provided by the fellow passenger terminal, wherein the travel route information includes a map for displaying a shortest travel route to the first destination from a real time position of the vehicle, and the driving information includes at least one piece of information of an expected time of arrival at the first destination or the second destination, a remaining travel distance, and a travel route.

According to embodiment, when the destination is input through some of a plurality of terminals installed in the driver's seat and the non-driver's seat of the vehicle, path guidance to the destination is provided through the driver terminal, and the driver may concentrate on driving.

According to embodiment, the occupant may provide accurate destination information to the driver by inputting the destination address through a fellow passenger terminal installed in the non-driver's seat.

### BRIEF DESCRIPTION OF THE DRAWINGS

FIG. 1 shows a taxi mobility system including a vehicle system according to an embodiment;

FIG. 2 shows a flowchart of a combined control method of a navigation terminal according to an embodiment;

FIG. 3 shows a flowchart of a combined control method of a navigation terminal according to another embodiment; and

FIG. 4 shows a flowchart of a combined control method of a navigation terminal according to the other embodiment.

### DETAILED DESCRIPTION OF ILLUSTRATIVE EMBODIMENTS

Hereinafter, embodiments disclosed in the present specification will be described in detail with reference to the accompanying drawings. In the present specification, the same or similar components will be denoted by the same or similar reference numerals, and an overlapped description thereof will be omitted. The terms “module” and “unit” for components used in the following description are used only in order to make the specification easier. Therefore, these terms do not have meanings or roles that distinguish them from each other by themselves. In describing embodiments of the present specification, when it is determined that a detailed description of the well-known art associated with the present invention may obscure the gist of the present invention, it will be omitted. The accompanying drawings are provided only in order to allow embodiments disclosed in the present specification to be easily understood and are not to be interpreted as limiting the spirit disclosed in the present specification, and it is to be understood that the present invention includes all modifications, equivalents, and substitutions without departing from the scope and spirit of the present invention.

Terms including ordinal numbers such as first, second, and the like, will be used only to describe various components, and are not interpreted as limiting these components. The terms are only used to differentiate one component from others.

It is to be understood that when one component is referred to as being “connected” or “coupled” to another component, it may be connected or coupled directly to another component or be connected or coupled to another component with the other component intervening therebetween. On the other hand, it is to be understood that when one component is referred to as being “connected or coupled directly” to another component, it may be connected or coupled to another component without the other component intervening therebetween.

It will be further understood that terms “comprises” or “have” used in the present specification specify the presence of stated features, numerals, steps, operations, components, parts, or a combination thereof, but do not preclude the presence or addition of one or more other features, numerals, steps, operations, components, parts, or a combination thereof.

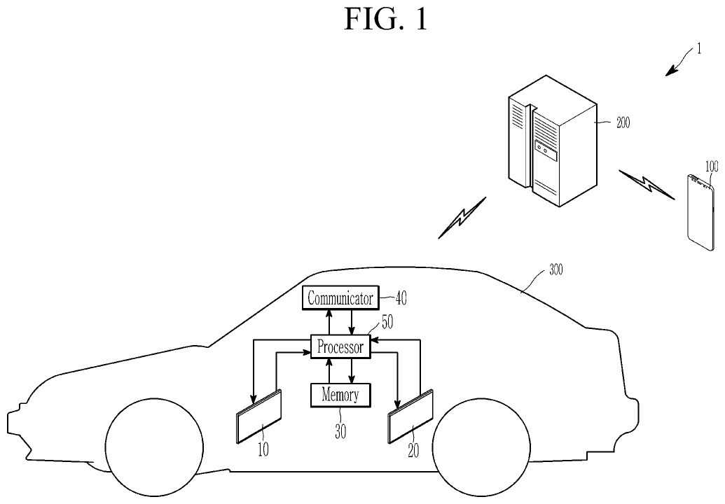

FIG. 1 shows a taxi mobility system including a vehicle system according to an embodiment.

Referring to FIG. 1, the taxi mobility system 1 includes an occupant portable terminal 100, a server 200, and a vehicle system 300.

The taxi mobility system 1 will be described to be a system for providing a service of matching an occupant and a taxi, and the vehicle system 300 is applied not only to the taxi that is a commercial vehicle but also to non-commercial vehicles.

The occupant portable terminal 100 may be a portable terminal in which an application (APP) for calling (CALL) a taxi positioned near so that the occupant may move to the destination.

The occupant portable terminal wo may include a mobile phone, a smart phone, a laptop computer, a digital broadcasting terminal, a personal digital assistant (PDA), a portable multimedia player (PMP), and a navigation device. However, the occupant portable terminal 100 is not limited thereto, and it may include digital TVs and desktop computers in which the application (APP) for calling (CALL) a taxi is installed so that the user may execute the application (APP) to call (CALL) a taxi.

The server 200 may be a server for providing a call-taxi service. Referring to FIG. 1, the call (CALL) signal output by an occupant portable terminal 100 possessed by at least one occupant is received, and the call signal may be transmitted to a plurality of vehicle systems 300 positioned near the occupant. Information on the responding vehicle system 300 is transmitted to the occupant portable terminal 100 to match the occupant portable terminal 100 and the vehicle system 300. Destination information may be included in the call (CALL) signal.

The server 200 may be a navigation server for providing real-time traffic information. When the vehicle system 300 transmits position and destination information of the current vehicle, the server 200 may transmit shortest travel route information to the vehicle system 300 according to real-time traffic information.

The vehicle system 300 includes a driver terminal 10, a fellow passenger terminal 20, a memory 30, a communicator 40, and a processor 50.

The driver terminal 10 may be a navigation device installed in a position (e.g., a front side or a lateral side of the driver) that is adjacent to the driver's seat.

For example, the driver terminal 10 includes a touchscreen (not shown), and it may receive destination information corresponding to a touch input of the driver. The touchscreen may include an On-cell type touch screen added to various types of displays such as a LCD, a PDP, an OLED, or a micro LED or an In-cell type touch screen integrally installed in the display.

For another example, when the communicator 40 receives the call signal from the remote occupant portable terminal 100, the driver terminal 10 may receive destination information included in the call signal by control of the processor 50.

According to an embodiment, the driver terminal 10 may execute a navigation program and may provide travel route information on the destination to the driver. The driver terminal 10 includes a display (not shown) and an audio unit (not shown), and may display the travel route information to the display and/or provide the same as a voice to the driver through the audio unit. The display may be various types of displays such as an LCD, a PDP, an OLED, or a micro LED, and the audio unit may include a speaker and an earphone.

The fellow passenger terminal 20 may be an electronic device installed in the position (e.g., a front side or a lateral side of the fellow passenger) that is adjacent to the non-driver's seat, and without being limited thereto, it may be configured with the navigation device. The fellow passenger may be a user who got in the vehicle in addition to the driver.

For example, the fellow passenger terminal 20 may include a touchscreen (not shown), and it may receive destination information corresponding to a touch input of the driver and may transmits the same to the processor 50. The processor 50 may transmit the destination information input by the fellow passenger terminal 20 to the driver terminal 10 to control the driver terminal 10 so that the navigation program may be executed by the driver terminal 10.

According to an embodiment, when the navigation program is executed by the driver terminal 10, the fellow passenger terminal 20 may provide driving information including at least one piece of information of an expected time of arrival at the destination, a remaining travel distance, and a travel route by control of the processor 50.

The memory 30 may store information on the navigation program executed by the driver terminal 10, the call signal transmitted by the server 200, the real time traffic information, and the shortest travel route.

The communicator 40 may include a communication module for supporting wireless communication with the server 200, and may transmit/receive data to/from the server 200.

When destination information is input through the driver terminal 10 or the fellow passenger terminal 20, the processor 50 may control the navigation program to be executed by the driver terminal 10, and the driving information to be provided by the fellow passenger terminal 20. According to an embodiment, the processor 50 may receive the destination information through the fellow passenger terminal 20 as well as the driver terminal 10. The processor 50 may control the navigation program to be executed by the driver terminal 10, and the driving information to be provided by the fellow passenger terminal 20.

A combined control method of a navigation terminal, and a vehicle system providing the method, will now be described with reference to FIG. 1 to FIG. 4.

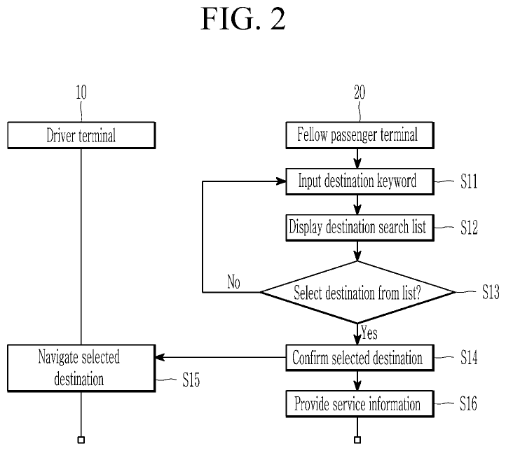

FIG. 2 shows a flowchart of a combined control method of a navigation terminal according to an embodiment.

Referring to FIG. 2, when an occupant (or a fellow passenger) inputs destination information through the fellow passenger terminal 20, the processor 50 may receive the destination information from the fellow passenger terminal 20 (S11).

On an initial screen without a predetermined input, the fellow passenger terminal 20 may display a screen for inputting a keyword of the destination. For example, the occupant sitting in the non-driver's seat may touch the fellow passenger terminal 20 installed on the front side or the lateral side of the occupant and may input the keyword on the destination, but he is not limited thereto, and he may input the voice and the entire address of the destination.

The processor 50 may display a plurality of destination lists corresponding to the destination keyword to the fellow passenger terminal 20 (S12).

The processor 50 may determine whether the occupant selects an arbitrary destination address from the destination lists (S13).

When the occupant does not select the destination address from the list according to a result of determination (No in S13), the processor 50 may again display the keyword input screen displayed in S11 to the fellow passenger terminal 20. For example, when the destination list is displayed, a predetermined time passes by, and there is no input information, the processor 50 may determine that the occupant did not select the destination address from the list.

When the occupant selects the destination address from the list according to the result of determination (Yes in S13), the processor 50 confirms the selected destination address, and controls the driver terminal 10 so that the navigation program for providing travel route information on the destination may be executed in the driver terminal 10 (S14 and S15). The travel route information may include a map for displaying the shortest travel route to the destination from a real time position of the vehicle.

The processor 50 may control the fellow passenger terminal 20 so that driving information including at least one piece of information of the expected time of arrival at the destination, the remaining travel distance, and the travel route may be provided by the fellow passenger terminal 20 (S16).

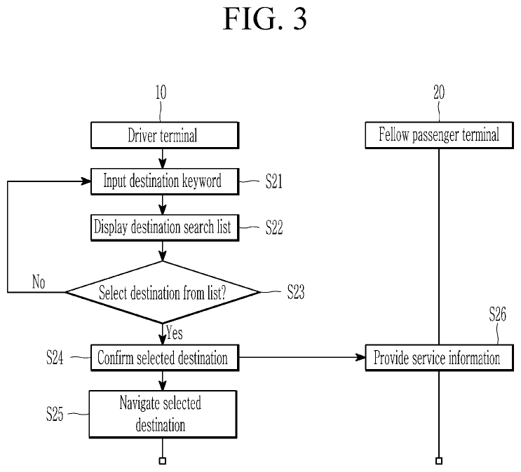

FIG. 3 shows a flowchart of a combined control method of a navigation terminal according to another embodiment.

Referring to FIG. 3, when the driver inputs destination information through the driver terminal 10, the processor 50 may receive destination information from the driver terminal 10 (S21).

On the initial screen without a predetermined input, the driver terminal 10 may display a screen for inputting the keyword on the destination. For example, the driver having sat in the driver's seat may touch the driver terminal 10 installed on the front side or the lateral side of the driver and may input the keyword on the destination, but he is not limited thereto, and he may input the voice and the entire address of the destination.

The processor 50 may display a plurality of destination lists corresponding to the destination keyword to the driver terminal 10 (S22).

The processor 50 may determine whether the driver selects an arbitrary destination address from the destination lists (S23).

When the driver does not select the destination address from the list according to a result of determination (No in S23), the processor 50 may again display the keyword input screen displayed in S21 to the driver terminal 10. For example, when the destination list is displayed, a predetermined time passes by, and there is no input information, the processor 50 may determine that the driver did not select the destination address from the list.

When the driver selects the destination address from the list according to the result of determination (Yes in S23), the processor 50 confirms the selected destination address, and controls the driver terminal 10 so that the navigation program for providing travel route information on the destination may be executed in the driver terminal 10 (S24 and S25).

The processor 50 may control the fellow passenger terminal 20 so that driving information including at least one piece of information of the expected time of arrival at the destination, the remaining travel distance, and the travel route may be provided by the fellow passenger terminal 20 (S26).

To sum up, referring to FIG. 2 and FIG. 3, the processor 50 may receive the destination information from the fellow passenger terminal 20 as well as from the driver terminal 10. The processor 50 may control the navigation program to be executed by the driver terminal 10, and the driving information to be provided to the fellow passenger terminal 20.

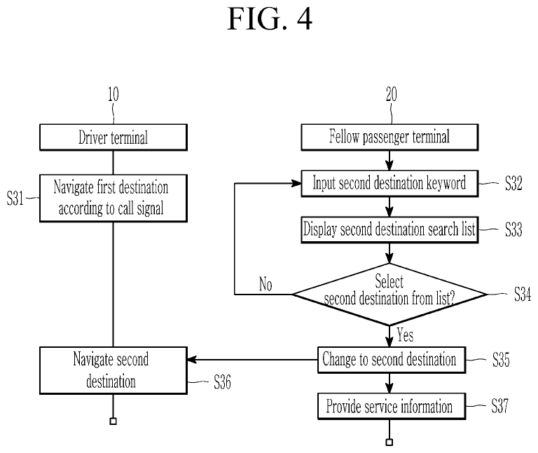

FIG. 4 shows a flowchart of a combined control method of a navigation terminal according to the other embodiment.

Referring to FIG. 4, the processor 50 controls the driver terminal 10 so that the navigation program on a first destination according to a call signal of the occupant may be executed by the driver terminal 10 (S31).

According to an embodiment, the processor 50 may receive a call signal of the occupant including destination information on the first destination from the server 200 through the communicator 40. When the processor 50 makes an acceptance on the call signal, matching is executed, and the occupant may get in the vehicle. For example, the driver may input information (or a button) for instructing the occupant to get in through the driver terminal 10. The processor 50 may control the driver terminal 10 so that the navigation program may be executed by the driver terminal 10.

The processor 50 may control the fellow passenger terminal 20 so that driving information including at least one piece of information of the expected time of arrival at the first destination, the remaining travel distance, and the travel route may be provided by the fellow passenger terminal 20.

When the occupant (or the fellow passenger) inputs second destination information through the fellow passenger terminal 20, the processor 50 may receive second destination information from the fellow passenger terminal 20 (S32).

On an initial screen without a predetermined input, the fellow passenger terminal 20 may display a screen for inputting a keyword of the destination. For example, the occupant having sat in the non-driver's seat may touch the fellow passenger terminal 20 installed on the front side or the lateral side of the occupant and may input the keyword on the second destination, but he is not limited thereto, and he may input the voice and the entire address of the second destination.

The processor 50 may display a plurality of second destination lists corresponding to the second destination keyword to the fellow passenger terminal 20 (S33).

The processor 50 may determine whether the occupant selects an arbitrary second destination address from the second destination lists (S34).

When the occupant does not select the second destination address from the list according to a result of determination (No in S34), the processor 50 may again display the keyword input screen displayed in S32 to the fellow passenger terminal 20. For example, when the destination list is displayed, a predetermined time passes by, and there is no input information, the processor 50 may determine that the occupant did not select the second destination address from the list.

When the occupant selects the destination address from the list according to the result of determination (Yes in S34), the processor 50 changes the first destination address to the second destination address, and controls the driver terminal 10 so that the navigation program for providing travel route information on the second destination may be executed by the driver terminal 10 (S35 and S36). The travel route information may include a map for displaying the shortest travel route to the destination from a real time position of the vehicle.

The processor 50 may control the fellow passenger terminal 20 so that driving information including at least one piece of information of the expected time of arrival at the second destination, the remaining travel distance, and the travel route may be provided by the fellow passenger terminal 20 (S37).

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims

What is claimed is:

1. A vehicle system comprising:
a driver terminal installed at a driver seat of a vehicle;
a fellow passenger terminal installed at a non-driver seat of the vehicle; and
a processor configured to control the driver terminal to execute a navigation program for providing travel route information for a first destination by the driver terminal when destination information of the first destination is received through the driver terminal or the fellow passenger terminal,
wherein the travel route information includes a map for displaying a shortest travel route to the first destination from a real-time position of the vehicle.

2. The vehicle system of claim 1, wherein the processor is configured to control the fellow passenger terminal to allow the fellow passenger terminal to provide driving information including at least one piece of information of an expected time of arrival at the first destination, a remaining travel distance, or a travel route when the navigation program is executed.

3. The vehicle system of claim 1, wherein the processor is configured to:
stop executing the travel route information for the first destination when destination information of a second destination is input through the driver terminal or the fellow passenger terminal while the navigation program for the first destination is executed, and control the driver terminal to execute the navigation program for providing travel route information for the second destination is executed by the driver terminal.

4. The vehicle system of claim 3, wherein the processor is configured to control the fellow passenger terminal to allow the fellow passenger terminal to provide driving information including at least one piece of information of an expected time of arrival at the second destination, a remaining travel distance, or a travel route when the navigation program for providing travel route information for the second destination is executed.

5. A vehicle system comprising:
a driver terminal installed at a driver seat of a vehicle;
a fellow passenger terminal installed at a non-driver seat of the vehicle;
a receiver configured to receive a call signal for an occupant including destination information on a first destination from a server; and
a processor configured to control the driver terminal to execute a navigation program for providing travel route information for the first destination by the driver terminal when the occupant enters the vehicle after accepting the call signal,
wherein the processor is configured to:
stop executing the travel route information for the first destination when destination information for a second destination is input through the fellow passenger terminal while the navigation program on the first destination is executed, and
control the driver terminal so that the navigation program for providing travel route information for the second destination is executed by the driver terminal, and wherein the travel route information includes a map for displaying a shortest travel route to the first destination or the second destination from a real time position of the vehicle.

6. The vehicle system of claim 5,
wherein the processor is configured to:
control the fellow passenger terminal so that first driving information for the first destination is provided by the fellow passenger terminal when destination information for the first destination is input, and
control the fellow passenger terminal so that second driving information in which the first destination is changed to the second destination is provided by the fellow passenger terminal when destination information for the second destination is re-input, and
wherein the first or second driving information includes at least one piece of information of an expected time of arrival at the first destination or the second destination, a remaining travel distance, or a travel route.

7. A method comprising:
inputting destination information through a fellow passenger terminal installed at a non-driver seat of a vehicle;
controlling a driver terminal to allow a navigation program for providing travel route information for a destination to be executed by the driver terminal installed at a driver seat of the vehicle; and
controlling the fellow passenger terminal to allow driving information including at least one piece of information of an expected time of arrival at the destination, a remaining travel distance, or a travel route to be provided by the fellow passenger terminal,
wherein the travel route information includes a map for displaying a shortest travel route to the destination from a real time position of the vehicle.

8. A method comprising:
controlling a driver terminal to allow a navigation program for providing travel route information for a destination to be executed by the driver terminal installed at a driver seat of a vehicle; and
controlling a fellow passenger terminal to allow driving information including at least one piece of information of an expected time of arrival at the destination, a remaining travel distance, or a travel route to be provided by the fellow passenger terminal installed at a non-drive seat of the vehicle,
wherein the travel route information includes a map for displaying a shortest travel route to the destination from a real time position of the vehicle.

9. The method of claim 8, further comprising, before controlling the driver terminal, inputting destination information through the driver terminal.
